(19) United States
(12) Patent Application Publication
(10) Pub. No.: US 2014/0321819 A1
(43) Pub. Date: Oct. 30, 2014

(54) OPTICAL ASSEMBLY

(71) Applicant: HON HAI PRECISION INDUSTRY CO., LTD., New Taipei (TW)

(72) Inventors: JIM ZHAO, Irvine, CA (US); YUAN-CHIEH LIN, Lake Forest, CA (US); JIA-HAU LIU, New Taipei (TW)

(73) Assignee: HON HAI PRECISION INDUSTRY CO., LTD., New Taipei (TW)

(21) Appl. No.: 13/869,212

(22) Filed: Apr. 24, 2013

(51) Int. Cl. G02B 6/42

(52) U.S. Cl. CPC G02B 6/4214
USPC 385/93

(57) ABSTRACT

An optical assembly (1) includes a socket (10) and an optical module (20). The socket includes a housing (11) and a number of contacts (12) received in the housing. The housing includes a bottom wall (110), side walls (111) extending upwardly form the bottom wall, and a receiving room (112) formed by the bottom and the side walls. The optical module is received in the receiving room and electrically connected with the contacts. The optical module includes a carrier (21), a lens array (22), and a waveguide (23) optically coupling with the lens array. The ferrule is used to align the waveguide with the lens array. The waveguide includes a number of reflection potions (232, 233) at an end thereof to change a transmission direction of an optical signal along a second direction with an angle relative to the first direction.

### BACKGROUND OF THE INVENTION

1. Field of the Invention

The present invention relates to an optical assembly, and more particularly to an optical assembly having a simple structure and low profile.

2. Description of Related Arts

U.S. Pat. No. 7,329,054, issued on Feb. 12, 2008, to Epitaux et al. discloses an optical assembly. The optical assembly comprises a socket connector and an optical transceiver mounted on the socket connector. The socket comprises a bottom and four side walls to form a receiving cavity. The bottom wall defines a recess extending through one of the side walls. A plurality of contacts are mounted on the bottom wall except for the recess region. The optical module comprises a substrate defining a recess, a lens received in the recess, a laser diode and a photodetector received in the recess and between the substrate and the lens, a ribbon of fibers in optical connection with the lens, and integrated circuits such as drivers, trans-impedance amplifiers, electro-optical converters, etc. mounted on the substrate.

U.S. Pat. No. 7,373,033, issued on May 13, 2008, to Lu et al. discloses an optical module. The optical module comprises a substrate, an optoelectronic member mounted to the substrate, an optical waveguide array disposed at a bottom side of the substrate, and a mechanical support to support the optical waveguide. The waveguide array comprises a pair of alignment pins to mate with corresponding alignment holes of the substrate, or vice versa.

An improved optical assembly is desired to offer advantages over the related art.

### SUMMARY OF THE INVENTION

An object of the present invention is to provide an optical assembly having a simple structure and low profile.

To achieve the above-mentioned object, an optical assembly comprises:

a socket comprising a housing and a plurality of contacts received in the housing, the housing comprising a bottom wall, a plurality of side walls extending upwardly from the bottom wall, and a receiving room formed by the bottom wall and the side walls; and

an optical module received in the receiving room and electrically connected with the contacts, the optical module comprising a carrier, a lens array mounted to a bottom of the carrier, and a waveguide extending along a first direction and optically coupling with the lens array, the lens array comprising a ferrule and a plurality of lens mounted on the ferrule, the ferrule comprising a flat wall, a pair of side walls extending from the flat wall, a receiving space formed by the flat wall and the side walls, and a first post projected from the flat wall into the receiving space along an upward direction, the side walls and the first post cooperating to align the waveguide with the lens array, the waveguide comprising a plurality of reflection potions at an end thereof to change a direction of an optical signal toward a second direction angled relative to the first direction.

According to the present invention, the waveguide comprises a plurality of reflection potions at an end thereof to change a transmission direction of an optical signal along a second direction with an angel relative to the first direction. There is no need to add additional reflection elements to the optical module. Therefore, the optical module can be designed to have a simple structure and smaller shape.

### BRIEF DESCRIPTION OF THE DRAWING

FIG. 1 is a perspective view of an optical assembly mounted on a PCB in accordance with the present invention;

FIG. 2 is a partly exploded view of the optical assembly and the PCB as shown in FIG. 1;

FIG. 3 is an exploded view of the optical assembly and the PCB as shown in FIG. 1;

FIG. 4 is another exploded view of the optical assembly and the PCB as shown in FIG. 3;

FIG. 5 is a cross-sectional view of the optical assembly taken along line 5-5 of FIG. 1;

FIG. 6 is a cross-sectional view of the optical assembly taken along line 6-6 of FIG. 1.

FIG. 7 is an exploded view of the optical module as shown in FIG. 3;

FIG. 8 is an exploded view of the optical module as shown in FIG. 4; and

FIG. 9 is a partial enlarged view of the dotted circle portion of FIG. 5.

### DETAILED DESCRIPTION OF THE PREFERRED EMBODIMENT

Reference will now be made in detail to a preferred embodiment of the present invention.

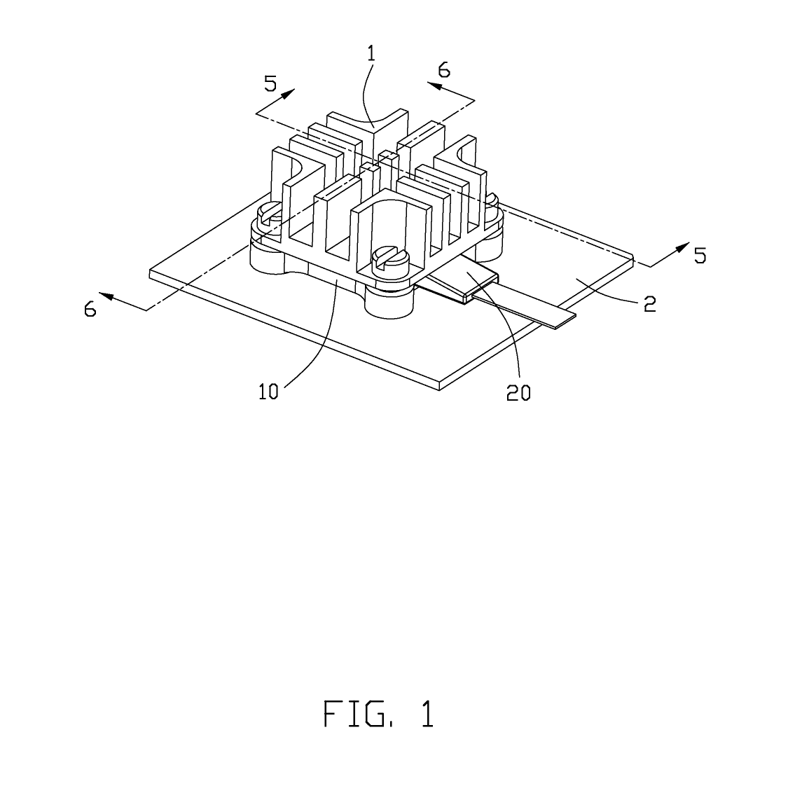

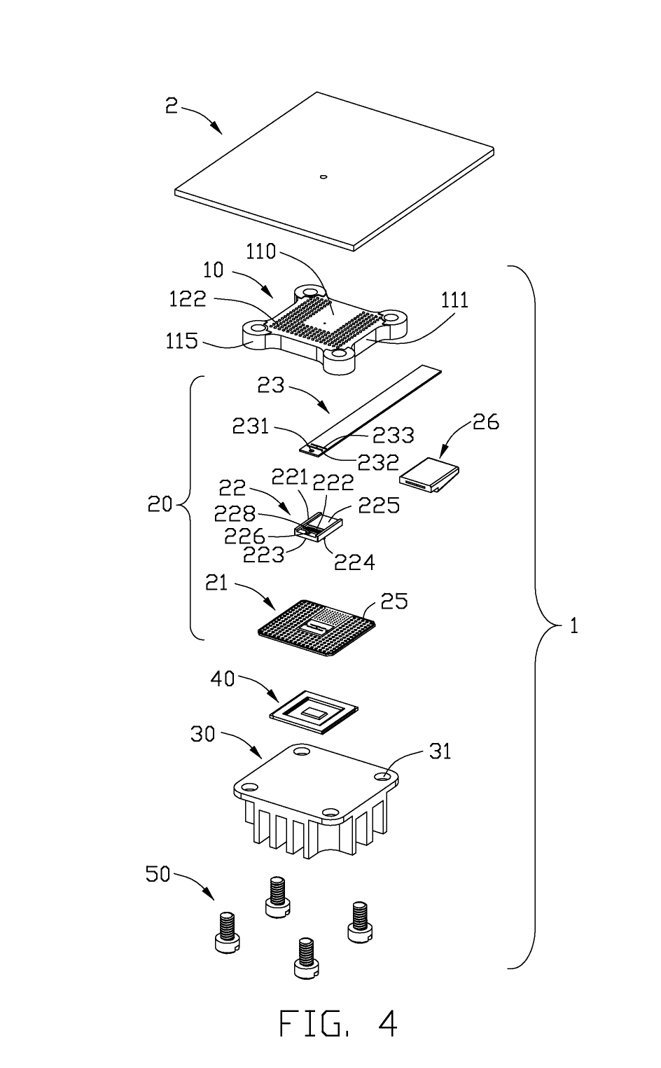

Referring to FIGS. 1 to 4, an optical assembly 1 is mounted on a printed circuit board 2 and comprises a socket 10 mounted on and electrically connected with the printed circuit board 2, a optical module 20 received in the socket 10, a heat sink 30 mounted to the socket 10, an integrated heat spreader 40 disposed between the heat sink 30 and the optical module 20, and four bolts 50 for fixing the heat sink 30 to the socket 10. The printed circuit board 2 comprises a plurality of conductive pads 200 for electrically connecting with the optical module 20.

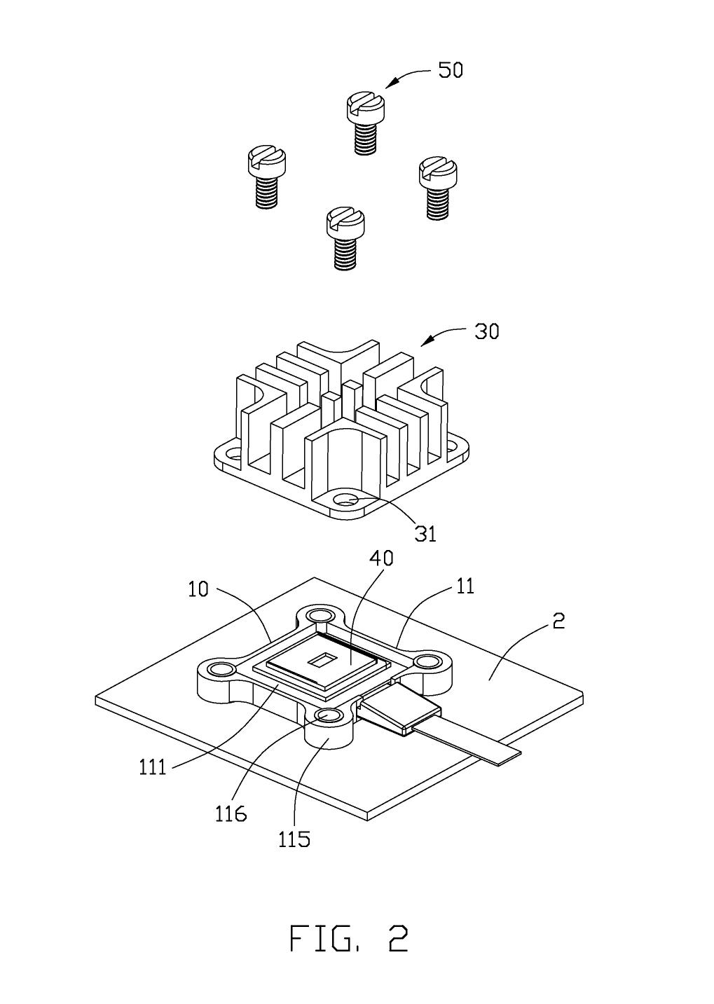

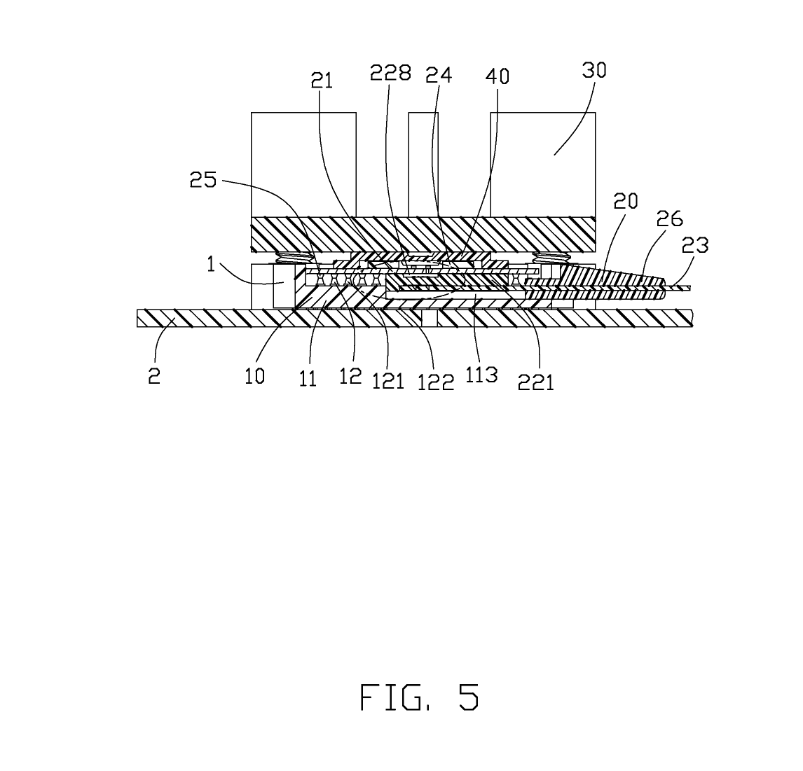

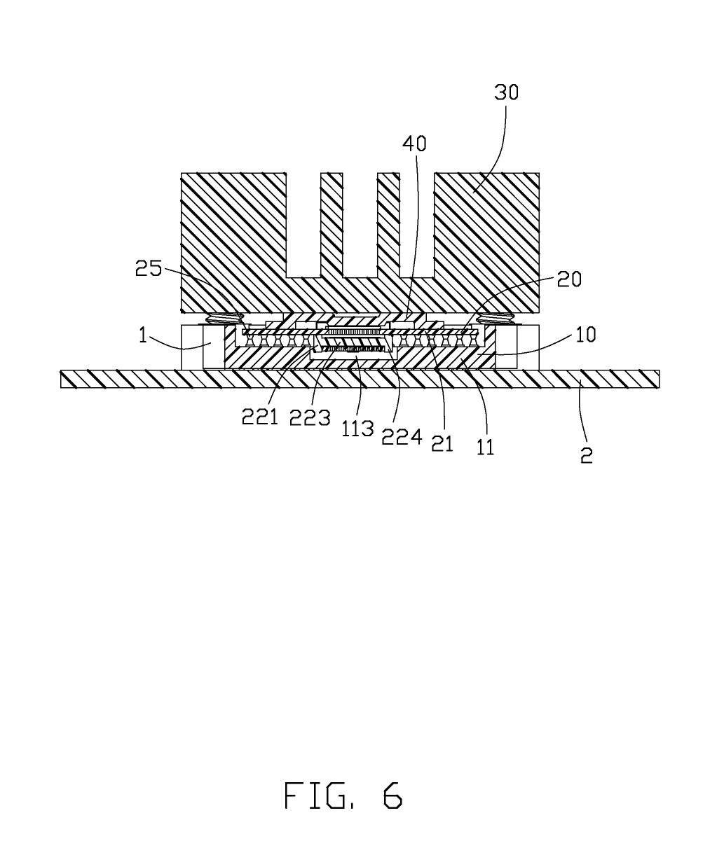

Referring to FIGS. 2 to 6, the socket 10 comprises a housing 11 and a plurality of contacts 12 mounted on the housing 11. The contacts 12 are arranged in a matrix. The housing 11 comprises a bottom wall 110 having four side edges, four side walls 111 respectively extending upwardly from the side edges of the bottom wall 110, and a receiving room 112 formed by the bottom wall 110 and the side walls 111. The housing 11 defines a recess 113 on the bottom wall 110 and extending through one of the side walls 111 formed a cutout 114. A portion of the optical module 20 is received in the recess 113. The housing 10 comprises four corners 115, each of the corners 115 formed by adjacent two side walls 111, each of the corners 115 defining a hole 116. The contacts 12 are mounted on the bottom wall 110 except for the region where the recess 113 is formed. Each of the contacts 12 comprises a mating end 121 exposed on the receiving room 112, and a mounting end 122 exposed on an opposite side of the bottom wall 110 for electrically connecting with the conductive pad 200.

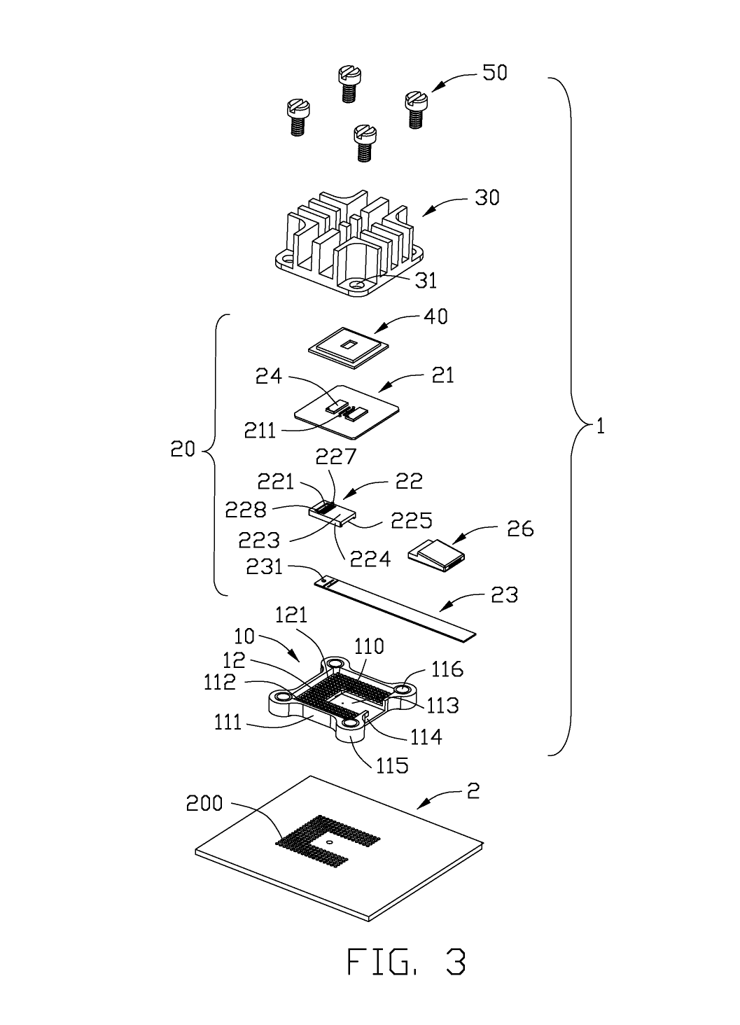

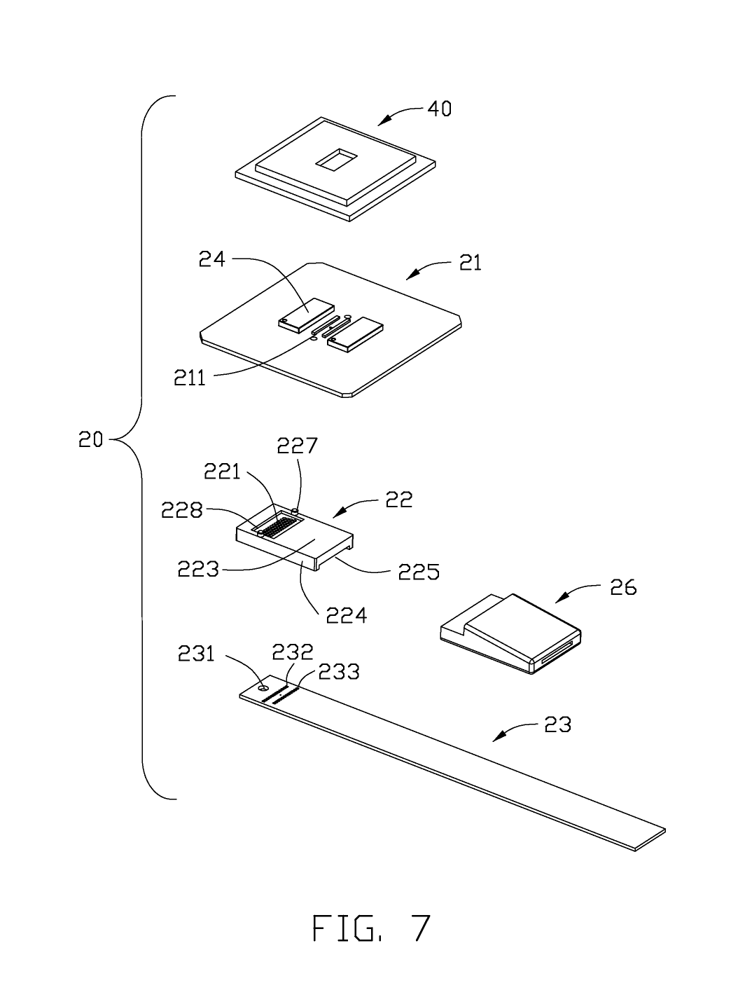

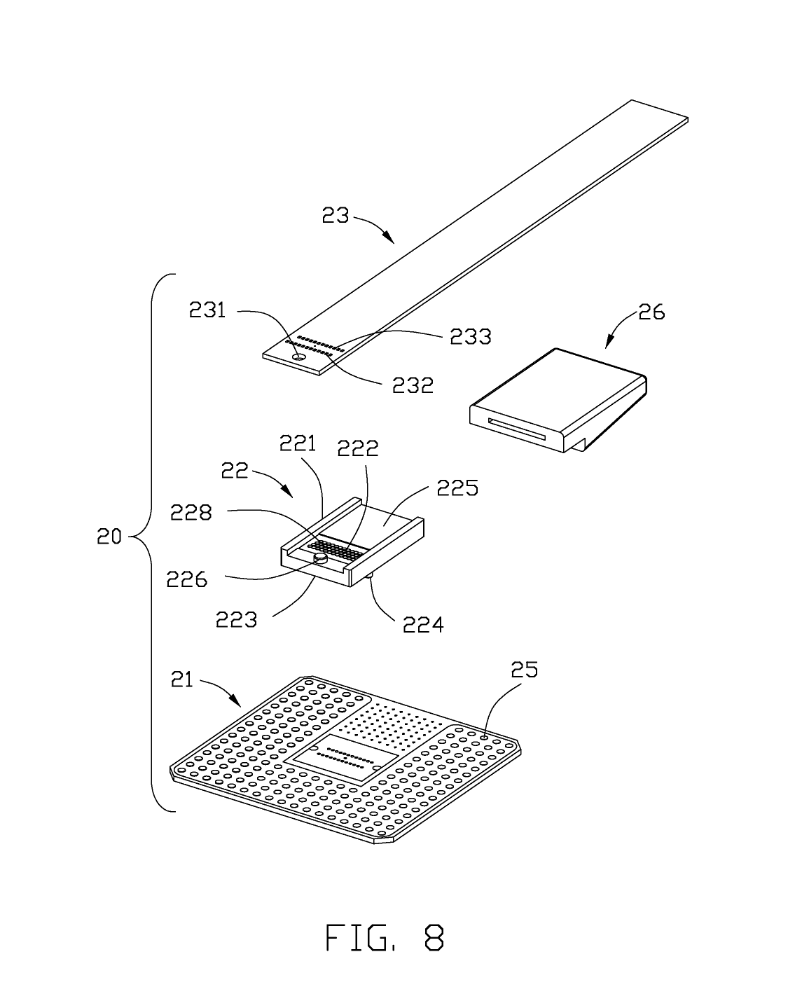

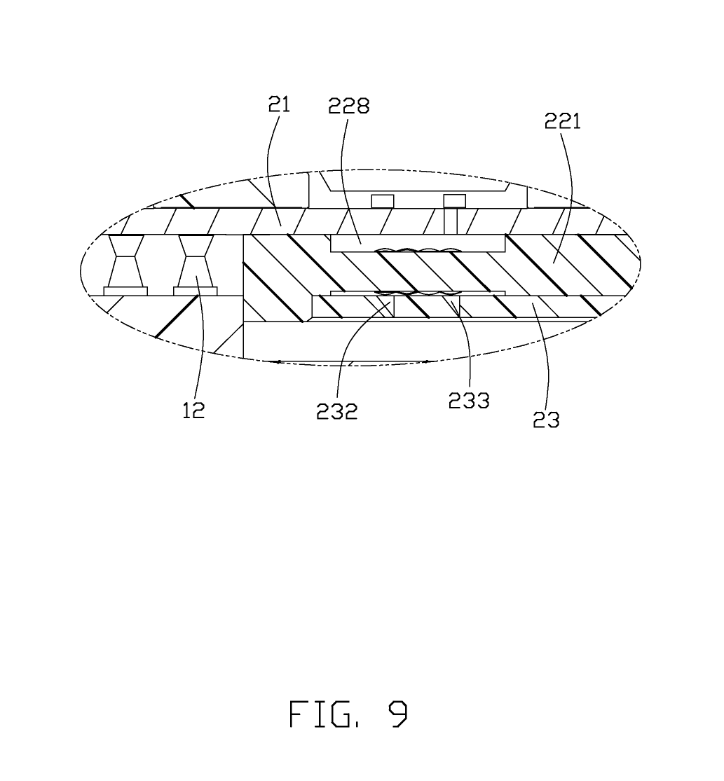

Referring to FIGS. 3 to 9, the optical module 20 comprises a carrier 21, a lens array 22 mounted on a bottom side of the carrier 21, a waveguide 23 optically connected with the lens array 22, an optical-electronic engine 24 mounted on a top side of the carrier 20 , a plurality of contacts 25 exposed at a bottom side of the carrier 21 for electrically connecting with the mating end 121 of contacts 12 of the socket 10, and a strain relief boot 26 molding on the waveguide 23. The waveguide 23 comprises a plurality of reflection or transferring portions 232, 233 to change the transmission direction of an optical signal and make the optical signal enter into the lens array 22 or the waveguide 23. The reflection portions 232, 233 are formed by laser ablation technology. The waveguide 23 defines a mounting hole 231 at an end of the waveguide 23. The optical-electronic engine 24 may comprise VCSEL, PD, driver IC, TIA IC, et al for converting optical signal to electronic signal or converting electronic signal to optical signal. Therefore, a signal transmitting between the waveguide 23 and the socket 10 is established. The lens array 22 is received in the recess 113. At least a portion of the strain relief boot 26 is received in and sealed with the cutout 114 of the socket 10 to prevent moisture, dust et al entered into the socket 10 from the cutout 114. The waveguide 23 is made of polymer material. Therefore, the optical module 20 would achieve more compact design.

The lens array 22 comprises a ferrule 221 and a plurality of lens 222 mounted on the ferrule 221. The ferrule 221 comprises a flat wall 223, a pair of opposite side walls 224 extending from a side of the flat wall 223 along a first direction, a receiving space 225 formed by the flat wall 223 and the side walls 224, a first post 226 projected from the side of the flat wall 223 into the receiving space 225 along the first direction to mating with the mating hole 231 of the waveguide 23, and a pair of second posts 227 projected from an opposite side of the flat wall 223 along a second direction opposite to the first direction. The side walls 224, the first post 226, and the mounting hole 231 cooperated to make the waveguide 23 align with the lens array 22. The carrier 21 defines a pair of through holes 211 to mate with the pair of second posts 227 to make the lens array 22 align with the carrier 21. The flat wall 223 defines a through hole 238, the lens 222 received into the through hole 238. The lens 222 has an outer dimension measured along a extending direction of the through hole 238 that is smaller than a dimension of the through hole measured along the extending direction. Therefore, the lens 222 is recessed in the flat wall 223.

The heat sink 30 defines four through holes 31. Each of the through hole 31 is aligned with the hole 116 of the socket 10 for insertion of the bolt to fix the heat sink 30 to the housing 11 of the socket 10 and make the contacts 25 of the carrier 25 press against the contacts 12 of the socket 10. The integrated heat spreader 40 is sandwiched between the heat sink 30 and the optical-electronic engine 24 to help spread the heat from the optical-electronic engine 24 to the heat sink 30.

It is to be understood, however, that even though numerous characteristics and advanarmes of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An optical assembly comprising:
a socket comprising a housing and a plurality of contacts received in the housing, the housing comprising a bottom wall, a plurality of side walls extending upwardly from the bottom wall, and a receiving room formed by the bottom wall and the side walls; and
an optical module received in the receiving room and electrically connected with the contacts, the optical module comprising a carrier, a lens array mounted to a bottom of the carrier, and a waveguide extending along a first direction and optically coupling with the lens array, the lens array comprising a ferrule and a plurality of lens mounted on the ferrule, the ferrule comprising a flat wall, a pair of side walls extending from the flat wall, a receiving space formed by the flat wall and the side walls, and a first post projected from the flat wall into the receiving space along an upward direction, the side walls and the first post cooperating to align the waveguide with the lens array, the waveguide comprising a plurality of reflection potions at an end thereof to change a direction of an optical signal toward a second direction angled relative to the first direction.

2. The optical assembly as recited in claim 1, wherein the ferrule comprises a pair of second posts projected from a side of the flat wall opposite to the first post along a downward direction, the carrier defining a pair of through holes to mate with the pair of second posts to align the lens array with the carrier.

3. The optical assembly as recited in claim 2, wherein the flat wall defines a through hole, and the lens is received into the through hole.

4. The optical assembly as recited in claim 3, wherein the lens has an outer dimension, measured along an extending direction of the through hole, smaller than a dimension of the through hole measured along the extending direction so that the lens is recessed in the flat wall.

5. The optical assembly as recited in claim 1, wherein the optical module comprises an optical-electronic engine mounted on a top surface of the carrier.

6. The optical assembly as recited in claim 5, further comprising a heat sink mounted on the socket, and an integrated heat spreader disposed between the heat sink and the optical-electronic engine.

7. The optical assembly as recited in claim 6, wherein the carrier comprises a plurality of contacts at the bottom side for electrically connecting with the contacts of the socket.

8. The optical assembly as recited in claim 7, further comprising a plurality of bolts to fix the heat sink to the socket and to press the contacts of the carrier against the contacts of the socket.

9. The optical assembly as recited in claim 1, wherein the waveguide is made of polymer material.

10. The optical assembly as recited in claim 1, wherein the housing defines a recess on the bottom wall, the recess extending through one of the side walls to form a cutout.

11. The optical assembly as recited in claim 10, wherein the optical module has a portion received in the recess and a strain relief boot molded on the waveguide, at least a portion of the strain relief boot being received in and sealed with the cutout.

12. The optical assembly as recited in claim 1, wherein the reflection portions are formed by laser ablation technology.

13. An optical assembly comprising:
a socket including a housing defining a bottom wall surrounded by a plurality of side walls to commonly define a receiving room, a recess formed in the bottom wall and communicating, in a transverse direction, with an exterior via a cutout in the corresponding side wall, a plurality of contacts disposed in the bottom wall of the housing, except in the recess, to upwardly communicate with the receiving room in a vertical direction perpendicular to said transverse direction;
an optical module including a carrier and a lens array under said carrier wherein said carrier is essentially snugly received in the receiving room and said lens array is essentially snugly received in the recess, said carrier including a plurality of terminals on an undersurface to mechanically and electrically connect to the corresponding contacts, respectively, said lens array including a plurality of lenses each defining at least a vertical optical path, a waveguide including a plurality of transferring portions aligned with the corresponding lenses for optical transmission, and an optical-electronic engine associated with the carrier to communicate with the lenses via the corresponding vertical optical paths; wherein
said waveguide extends out of the socket in said transverse direction.

14. The optical assembly as claimed in claim 13, wherein said lens array defining a receiving space within which a front end portion of the waveguide is received.

15. The optical assembly as claimed in claim 13, wherein said transferring portions are essentially reflectors to change an optical path from said transverse direction to said vertical direction.

16. The optical assembly as claimed in claim 13, wherein said optical-electronic engine is located on an upper face of the carrier opposite to the lens array.

17. The optical assembly as claimed in claim 13, where a heat spreader is located upon the carrier and at least partially within the receiving room.

18. The optical assembly as claimed in claim 17, wherein a heat sink is located upon the heat spreader and fastened to the socket.

19. The optical assembly as claimed in claim 13, wherein the transferring portions are aligned with the corresponding lenses in said vertical direction.

20. The optical assembly as claimed in claim 13, further including a printed circuit board to which the socket is mounted.
